(19) United States
(12) Patent Application Publication
(10) Pub. No.: US 2003/0150096 A1
(43) Pub. Date: Aug. 14, 2003

(54) Method of forming joint between an elongate members and socket

(76) Inventor: Richard Arthur Lindsay, Eye, Suffolk (GB)

Correspondence Address: William B Patterson, Moser Patterson & Sheridan, Suite 1500, 3040 Post Oak Boulevard, Houston, TX, 77056, US

(21) Appl. No.: 10/333,116

(22) PCT Filed: Jul. 16, 2001
(86) PCT No.: PCT/GB01/03177

(30) Foreign Application Priority Data
Jul. 14, 2000 (GB) 0017411.0

(51) Int. Cl. B23P 25/00

(52) U.S. Cl. 29/458

(57) ABSTRACT

The disclosure relates to a method of forming a joint between an elongate member (10) and a socket comprising the steps of forming a socket (16) in a body (11) to receive an end of a member with a clearance (14) except at the mouth of the socket. An annular recess (17) is formed around the socket and an injection passage (18) for adjesive extends through the body into the recess. An end of a member is located in the socket and adhesive is injected through the passage into the recess to spread throughout and fill the clearance between the member end and socket to set and lock the member end in the socket.

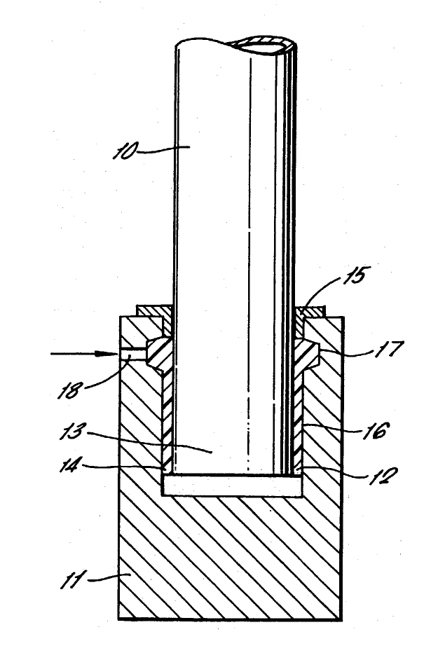

This invention relates to methods of forming joints between elongate members and sockets. The method is particularly although not exclusively applicable to the forming of components for camera tripod legs such as disclosed in our British patent publication nos. 2246600 and 2262306 which describe tripod legs in which pairs of parallel tubes are mounted at their ends in sockets in bridge members.

This invention provides a method of forming a joint between an elongate member and a socket comprising the steps of forming a socket in a body to receive an end of a member with a clearance except at the mouth of the socket, forming an annular recess around the socket and an injection passage for adhesive extending through the body into the recess, locating a member end in the socket and injecting adhesive through the passage into the recess to spread throughout and fill the clearance between the member end and socket to set and lock the member end in the socket.

A seal may be provided in the mouth of the socket to engage and locate the member end in the socket with a clearance all round the member end and to prevent loss of adhesive at the mouth of the socket.

More specifically, the seal may comprise an L-section collar fitted around the mouth of the socket to receive the member.

In any of the above methods, the socket may be formed by a blind hole in the body.

Also in any of the above methods a vent hole may be provided in the socket remote for the injection passage and mouth of the socket to release air from the socket as adhesive is injected into the socket.

The following is a description of a specific embodiment according to the invention with reference being made to the accompanying diagrammatic illustration showing the joint between a tube end and a socket.

The drawing shows a joint between a tube 10 and a bridging member 11 which form part of a leg construction for a camera supporting tripod as described and illustrated in our British patent publication nos. 2246600 and 2262306. The bridging member is formed with a blind socket 12 to receive an end portion 13 of the tube 10 with a small clearance indicated at 14 around the periphery and end of the tube. The clearance is closed at the open end of the socket by a rubber seal in the form of a L-section collar 15 which is a press fit in the open end of the socket. The seal engages and supports the tube end co-axially in the socket with a uniform clearance between the tube all round the socket.

Immediately below the collar 15 the peripheral wall 16 of the socket is formed with an annular recess 17 with an inlet aperture 18 through the wall of the bridging member leading into the recess. A high pressure supply of adhesive is connected to the aperture 18 to deliver a predetermined quantity of adhesive to the socket when securing the tube end in the socket. The socket has a vent hole (not shown) preferably located centrally at the bottom of the socket to release air from the socket as adhesive is injected into the socket.

The procedure for securing the tube end in the socket will now be described. Firstly, the tube end is located in the socket leaving the clearance 14 all round the tube end to provide a gap to receive adhesive for securing the tube end in the socket. The gap is closed at the mouth of the socket by the collar 15 which, as indicated above, is a press fit in the mouth of the socket. The tube seals with the collar to prevent loss of adhesive from the socket.

Adhesive is then pumped through the aperture 18 into the annular recess 17. The adhesive flows readily round the recess and after filling the recess spreads as a generally uniform curtain of adhesive down the gap 14 between the periphery of the tube and the socket. The annular recess therefore ensures that the gap 14 around the tube end is filled uniformly with adhesive and not preferentially on the side of the socket where the adhesive is introduced.

The adhesive is allowed to set and a strongly bonded joint between the tube end and bridging member is thereby formed.

1. A method of forming a joint between an elongate member and a socket comprising the steps of forming a socket in a body to receive an end of a member with clearance except at the mouth of the socket, forming an annular recess around the socket and an injection passage for adhesive extending through the body into the recess, locating a member end in the socket and injecting adhesive through the passage into the recess to spread throughout and fill the clearance between the member end and socket to set and lock the member end in the socket.

2. A method as claimed in claim 1, wherein a seal is provided in the mouth of the socket to engage and locate the member end in the socket with a clearance all round the member end and to prevent loss of adhesive at the mouth of the socket.

3. A method as claimed in claim 2, wherein the seal comprises an L-section collar fitted around the mouth of the socket to receive the member.

4. A method as claimed in any of the preceding claims, wherein the socket is formed by a blind hole in the body.

5. A method as claimed in any of the preceding claims, wherein a vent hole is provided in the socket remote for the injection passage and mouth of the socket to release air from the socket as adhesive is injected into the socket.
